(19) United States
(12) Patent Application Publication
(10) Pub. No.: US 2003/0092460 A1
(43) Pub. Date: May 15, 2003

(54) Mobile terminal apparatus

(75) Inventor: Mikiya Hayashi, Tokyo (JP)

Correspondence Address: BACON & THOMAS, PLLC, 625 SLATERS LANE, FOURTH FLOOR, ALEXANDRIA, VA, 22314

(73) Assignee: Hitachi Kokusai Electric Inc., Tokyo (JP)

(21) Appl. No.: 10/093,694

(22) Filed: Mar. 11, 2002

(30) Foreign Application Priority Data
Nov. 9, 2001 (JP) 2001-344332

(51) Int. Cl. H04B 7/00

(52) U.S. Cl. 455/522; 455/517

(57) ABSTRACT

A mobile terminal apparatus processes reception of data units in an effective manner such that the overall power consumption and excessive reception processing overhead thereof are substantially reduced. If a destination of a data unit received by the mobile terminal apparatus is found not to be the mobile terminal apparatus, the mobile terminal apparatus is controlled not to receive at least a portion of data units following the received data unit. Further, the mobile terminal apparatus includes a power control unit for controlling operational power supplied to a RF (radio frequency) unit which processes the reception of data units, to thereby control the RF unit not to receive at least a portion of the data units following the received data unit.

### FIELD OF THE INVENTION

The present invention relates to a mobile terminal apparatus for receiving sequentially a plurality of data units generated by segmenting a series of user data; and, more particularly, to a mobile terminal apparatus capable of preventing an unnecessary portion of the data units from being received by the apparatus so that the overall power consumption and reception process overhead thereof can be substantially reduced.

### BACKGROUND OF THE INVENTION

Recently, there have appeared various popular mobile terminal apparatus such as cellular phones, personal computers and mobile tools capable of transceiving data as well as voice messages in wireless communication. These apparatus may receive image and audio data from an information source through wireless communication connections and output the received data on a screen or through a speaker.

For instance, as shown in FIG. 1, a mobile terminal apparatus 1 receives data from other terminal apparatus or servers in a public network 3 by performing a wireless communication with a base station 2 coupled to the public network 3. And then, the mobile terminal apparatus 1 outputs the data on a screen or through a speaker.

The wireless communication between the mobile terminal apparatus 1 and the base station 2 can be carried out in accordance with the TDMA (time division multiple access) protocol. Further, a whole communication system based on the TDMA protocol can be configured in accordance with a mobile data communication standard, e.g., RCR STD-27 of PDC (personal digital cellular) technology.

In such a wireless communication system, in order to accommodate and enable a plurality of users to be connected to a network cell, a control channel in addition to a voice channel is usually established. The control channel is called a common access channel (CAC) since it is shared by a plurality of mobile terminal apparatus. The CAC can be used as a channel for specific purposes, e.g., user packet channel (UPCH) for carrying user data packets.

FIG. 9 illustrates a sequence of time slots and a data format for a reception slot of UPCH in accordance with TDMA and RCR STD-27. FIGS. 10A to 10E show data units to be transmitted through UPCH.

As shown in FIG. 9, a sequence of TDMA time slots includes a repeated series of a transmission slot Tx, a reception slot Rx and an idle slot I. The reception slot Rx, which is a time slot to be received by the mobile terminal apparatus 1, includes a burst excess response card time R (4 bytes), a preamble P (2 bytes), a control signal CAC (112 bytes), a synchronization word SW (20 bytes), a color code CC (8 bytes), another control signal CAC (112 bytes) and a collision control bit E (22 bytes).

In general, each of the control signals CAC's, which are transmitted through UPCH, contains one of data units generated by segmenting a series of user data. In the reception slot Rx of FIG. 9, a data unit is further segmented into two data subunits each of which is contained in each of the two control signals CAC's.

FIGS. 10A to 10E exhibit data formats of the data units produced by performing a channel decoding of UPCH.

As shown in FIGS. 10A to 10C, the data units are categorized into several types: i.e., a head unit (a), an intermediate unit (b) and a tail unit (c). Each of the data units (a) to (c) contains information (10, 00 or 01) representing the type of the data unit, the number of remaining data units Wr or the number of available bytes L, and unit data (higher than layer 2).

Further, as shown in FIGS. 10D and 10E, if a whole series of user data (1 message) can be contained in a data unit as unit data, the type of the data unit (d) is represented by 11. The data unit (d) also contains the number of available bytes L and unit data (higher than layer 2). An idle unit (e) is used for containing a segment of idle data. The idle unit (e) is represented by 00 and subsequent 000000 and further contains the number of remaining idle units I.

The unit data (higher than layer 2) included in each of the data units (a) to (c) shown in FIGS. 10A to 10C contains address information, i.e., destination of the data unit in accordance with the OSI (open systems interconnection) reference model.

As described above, a series of user data (especially when the length of the user data is too large to be carried through a communication channel) is divided into several data units to be received by mobile terminal apparatus. Recently, an increasing number of mobile terminal apparatus employ such data units for retrieving e-mail messages and accessing Internet web sites.

Meanwhile, the mobile terminal apparatus has a limited power supply due to its compact-sized battery. Therefore, if the mobile terminal apparatus does not process reception of the data units in a very effective manner, the operating time of the battery can be severely curtailed and the reception process overhead also will be increased. Moreover, such would adversely affect the operation of other processing units in the mobile terminal apparatus.

In particular, in case a plurality of mobile terminal apparatus share UPCH of CAC for communicating data units with each other, the mobile terminal apparatus must receive all data units transmitted through UPCH even if the data units are irrelevant to the mobile terminal apparatus. This aggravates the problem of power consumption and reception processing overhead in the mobile terminal apparatus.

### SUMMARY OF THE INVENTION

It is, therefore, an object of the present invention to provide a mobile terminal apparatus capable of preventing an unnecessary portion of the data units from being received by the apparatus so that the overall power consumption and reception processing overhead thereof can be substantially reduced.

In accordance with a preferred embodiment of the present invention, there is provided a mobile terminal apparatus for receiving sequentially a first data unit and remaining data units following the first data unit, the first data unit and the remaining data units being generated by segmenting a series of user data and the first data unit including information on a destination of the first data unit, characterized in that if the information indicates that the destination is not the mobile terminal apparatus, the mobile terminal apparatus is controlled not to receive at least a portion of the remaining data units. For example, if the mobile terminal apparatus receives a head unit which is not directed to the mobile terminal apparatus, the mobile terminal apparatus receives only a necessary portion, e.g., a synchronization word SW and a color code CC, of data units following the head unit. Consequently, the mobile terminal apparatus minimizes computational resources used to process reception of data units irrelevant thereto, resulting in the reduction of the overall power consumption and reception processing overhead thereof.

In accordance with another preferred embodiment of the present invention, there is provided a mobile terminal apparatus for receiving sequentially a first data unit and remaining data units following the first data unit, the first data unit and the remaining data units being generated by segmenting a series of user data and including information on the respective types of the data units, characterized in that if the information indicates that the first data unit is not received by the mobile terminal apparatus, the mobile terminal apparatus is controlled not to receive at least a portion of the remaining data units. For example, regardless of whether the destination of a head unit is the mobile terminal apparatus or not, if the mobile terminal apparatus cannot receive the head unit, the mobile terminal apparatus receives only a necessary portion of data units following the head unit. As a result, the mobile terminal apparatus minimizes computational resources used to process the reception of data units, in case that a head unit preceding the data units fails to reach the mobile terminal apparatus, so that the overall power consumption and reception processing overhead thereof can be reduced.

In accordance with still another preferred embodiment of the present invention, there is provided a mobile terminal apparatus for receiving sequentially a first data unit and remaining data units following the first data unit, the first data unit and the remaining data units being generated by segmenting a series of user data and including information on the respective types of the data units, characterized in that if the information indicates that the first data unit is an idle unit, the idle unit containing data unavailable to the mobile terminal apparatus, the mobile terminal apparatus is controlled not to receive at least a portion of the remaining data units. Therefore, the mobile terminal apparatus receives only a portion of the idle units, the portion being necessary for controlling the mobile terminal apparatus, to thereby economize the overall power consumption and reception processing overhead thereof.

Herein, the mobile terminal apparatus in accordance with the present invention preferably includes a power control unit for controlling operational power supplied to a RF (radio frequency) unit which processes reception of the first data unit and the remaining data units, to thereby control the RF unit not to receive at least a portion of the remaining data units.

Further, although the mobile terminal apparatus in accordance with the present receives only a portion of data units except data units containing user data or idle data (e.g., CAC as illustrated in FIG. 9), the mobile terminal apparatus can be controlled not to receive any portion of the data units. For example, according to RCR STD-27, a synchronization word SW and a color code CC of the reception slot Rx shown in FIG. 9 should be received by the mobile terminal apparatus for detecting an asynchronous state and a frequency cut-off, determining a resident zone, and controlling FEC (forward error correction).

### BRIEF DESCRIPTION OF THE DRAWINGS

The above and other objects and features of the present invention will become apparent from the following description of preferred embodiments given in conjunction with the accompanying drawings, in which:

FIG. 1 illustrates a wireless communication system employing a mobile terminal apparatus in accordance with a first preferred embodiment of the present invention;

FIGS. 2 and 3 exhibit structures of the mobile terminal apparatus in accordance with the first preferred embodiment shown in FIG. 1;

FIG. 4 shows a flowchart showing the operation of a mobile terminal apparatus in accordance with a second preferred embodiment of the present invention;

FIGS. 5 to 8 depict TDMA time slots, streaming formats of UPCH in accordance with RCR STD-27 and timing charts to show the operational power consumption reduction of a mobile terminal apparatus in accordance with the preferred embodiments of the present invention;

FIG. 9 exemplifies a sequence of time slots and a data format for a reception slot of UPCH in accordance with TDMA and RCR STD-27; and

FIGS. 10A to 10E describe data formats of the data units produced by performing a channel decoding of UPCH.

### DETAILED DESCRIPTION OF THE PREFERRED EMBODIMENTS

The preferred embodiments of the present invention will now be described in detail with reference to the accompanying drawings.

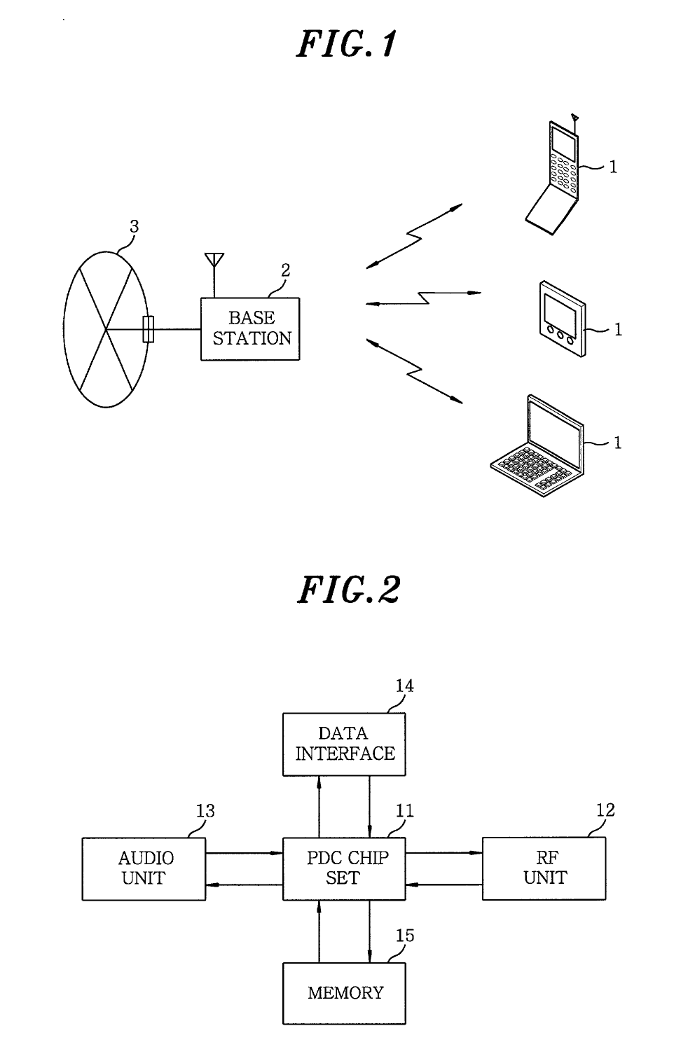

FIG. 1 illustrates a wireless communication system employing a mobile terminal apparatus in accordance with a first preferred embodiment of the present invention.

As shown in FIG. 1, the mobile terminal apparatus 1 of the first preferred embodiment receives data from an information source, e.g., other terminal apparatus or servers in a public network 3 by performing a wireless communication with a base station 2 coupled to the public network 3. And then, the mobile terminal apparatus 1 outputs the data on a screen or through a speaker. That is, the mobile terminal apparatus 1 can perform data communication with other terminal apparatus via the base station 2 by displaying character messages or image data on a screen, e.g., a LCD display panel, as well as communicating voice messages through a speaker or a microphone.

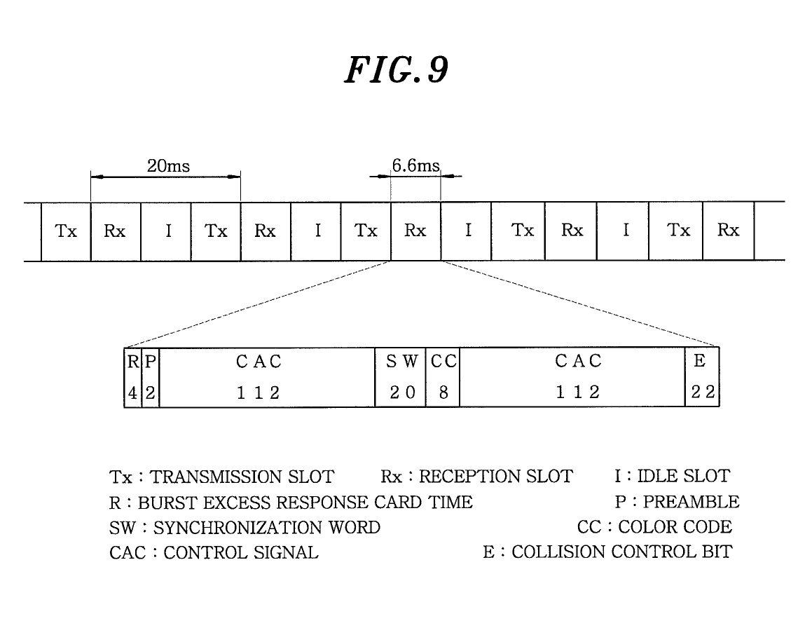

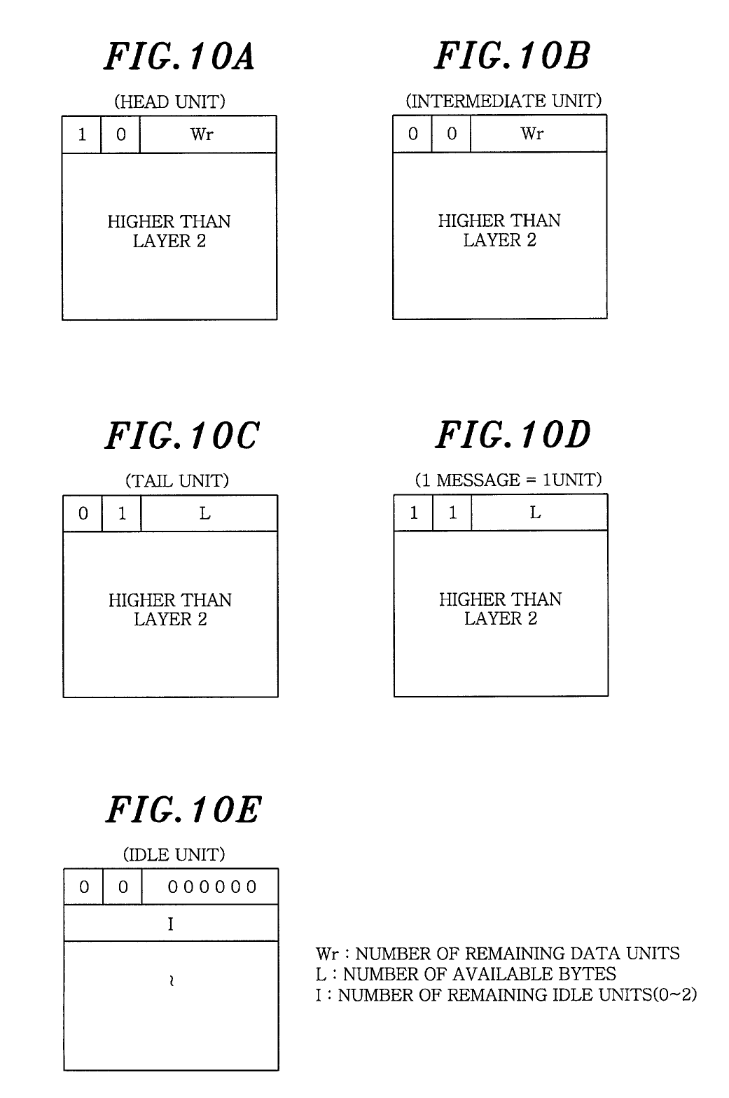

In the first embodiment, as described with reference to FIGS. 9 and 10, a wireless communication between the mobile terminal apparatus 1 and the base station 2 is implemented based on the TDMA and RCR STD-27 standard. Further, the mobile terminal apparatus 1 transceives data from/to the base station 2 by using UPCH as a common access channel.

FIG. 2 shows main components of the mobile terminal apparatus 1 in accordance with the first embodiment of the present invention. The mobile terminal apparatus 1 includes a PDC (personal digital cellular) chip set 11 for controlling wireless communications, a RF unit 12 for receiving/transmitting data through wireless communications, a microphone for inputting voice messages (not illustrated), a speaker for outputting voice messages (not illustrated), an audio unit 13 having a signal processor for audio I/O, a data interface 14 for inputting data from a user and displaying data received through the RF unit 12 and a memory 15 for storing user information or a control program to be executed by the PDC chip set 11.

The PDC chip set 11 executes the control program stored in the memory 15 so that the mobile terminal apparatus 1 can control the RF unit 12 to receive data to be stored in the memory 15, the audio unit 13 and the data interface 14 to input or output the data. Further, by performing such control, the mobile terminal apparatus 1 can perform reception of data through a wireless communication in accordance with the present invention.

FIG. 3 depicts a structure of the PDC chip set 11 which controls the data reception process in accordance with the first embodiment of the present invention. The PDC chip set 11 includes a power control unit 11a for controlling power supplied to the RF unit 12 and a central processing unit (CPU) 11b for controlling the power control unit 11a based on data units received by the RF unit 12.

In the mobile terminal apparatus of the first embodiment, based on data units received by the RF unit 12, the CPU 11b controls the power control unit 11a to restrain the reception of data units irrelevant to the mobile terminal apparatus.

The reception process of the mobile terminal apparatus now will be described in more detail.

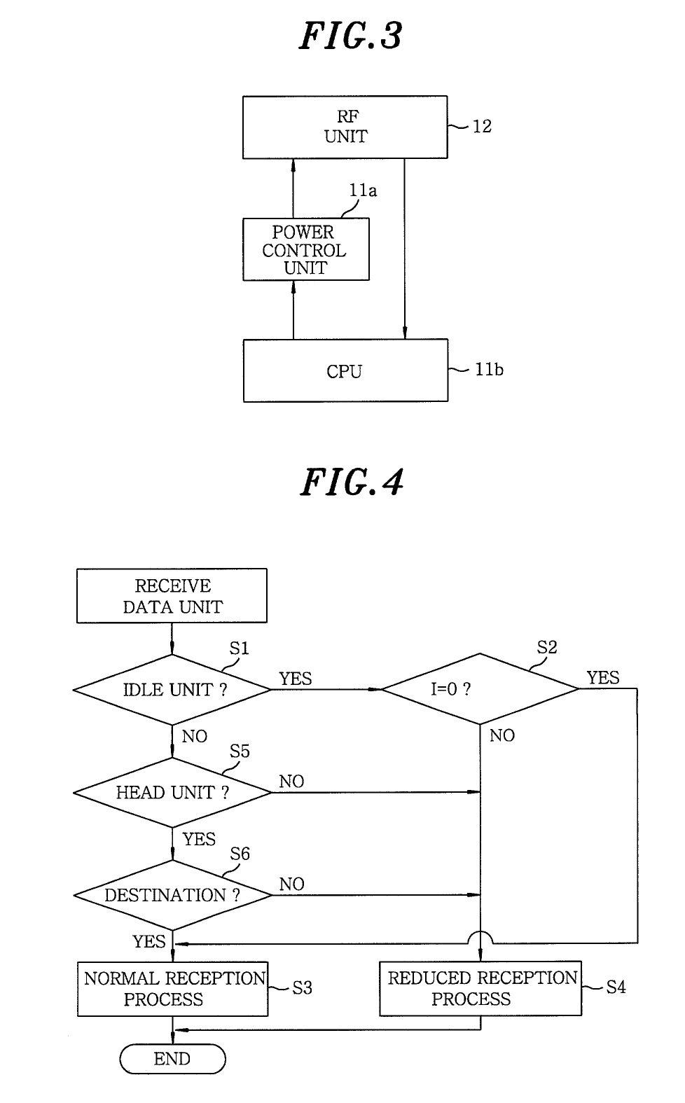

FIG. 4 shows a flowchart showing the operation of a mobile terminal apparatus in accordance with a second preferred embodiment of the present invention.

Once the RF unit 12 receives a data unit through UPCH, the CPU lib determines the type of the received data unit based on the information on the type thereof. In this embodiment, as shown in FIGS. 10A to 10E, the above unit type determination process is performed based on identification information included as a header for unit data (higher than layer 2) of the data unit: i.e., 10, 00, 01, the number of remaining data units Wr and the number of available bytes L for data units (a) to (c); and 11, 00/000000, the number of available bytes L and the number of remaining idle units I for data units (d) and (e).

If the received data unit is found to be an idle unit (step S1), the CPU 11b checks the number of remaining idle units I to determine the mode of the reception process to be executed by the RF unit 12 (step S2). If I is equal to 0 (i.e., if there is no idle unit following the received idle unit), the mobile terminal apparatus 1 performs a normal reception process (step S3).

On the other hand, if I is larger than 0 (i.e., if there are any idle units following the received idle unit), the CPU 11b controls the power control unit 11a to control the power supplied to the RF unit 12 (step S4) so that the RF unit 12 receives only a portion of the remaining idle units.

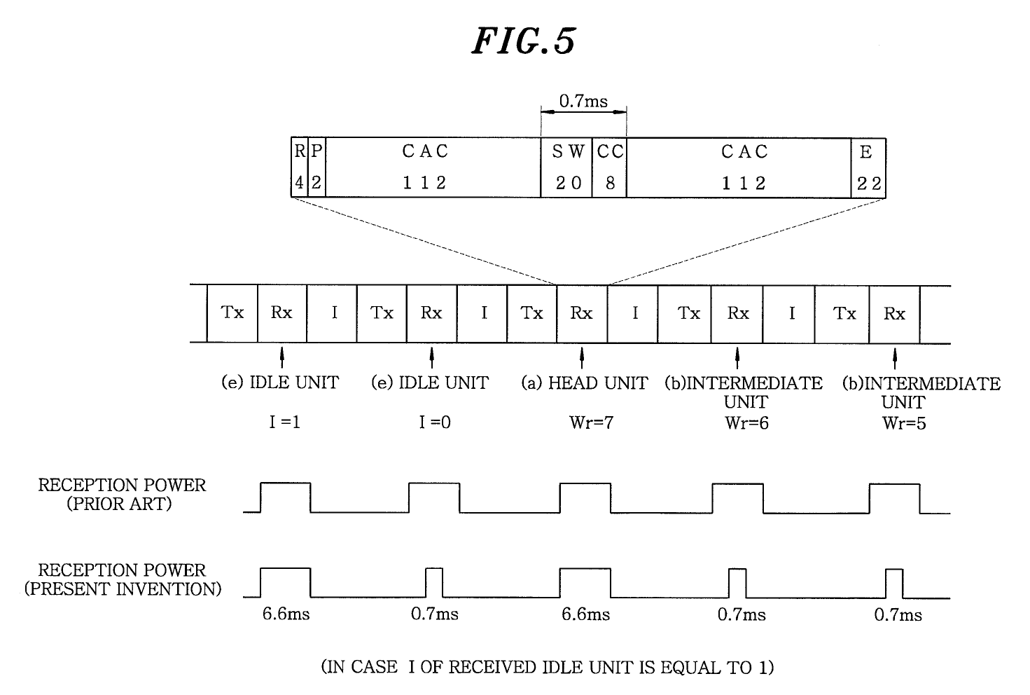

For example, referring to FIG. 5, if I of the received idle unit is equal to 1, the power control unit 11a provides the RF unit 12 with operational power during a period of time (0.7 ms) corresponding to a portion (SW and CC) of the next reception slot Rx. Therefore, in comparison with the prior art which supplies operational power to the RF unit 12 during a period of time (6.6 ms) corresponding to the entire reception slot Rx, the present invention can significantly reduce the power consumption and process overhead thereof by truncating the unnecessary data units, while retaining the necessary control data.

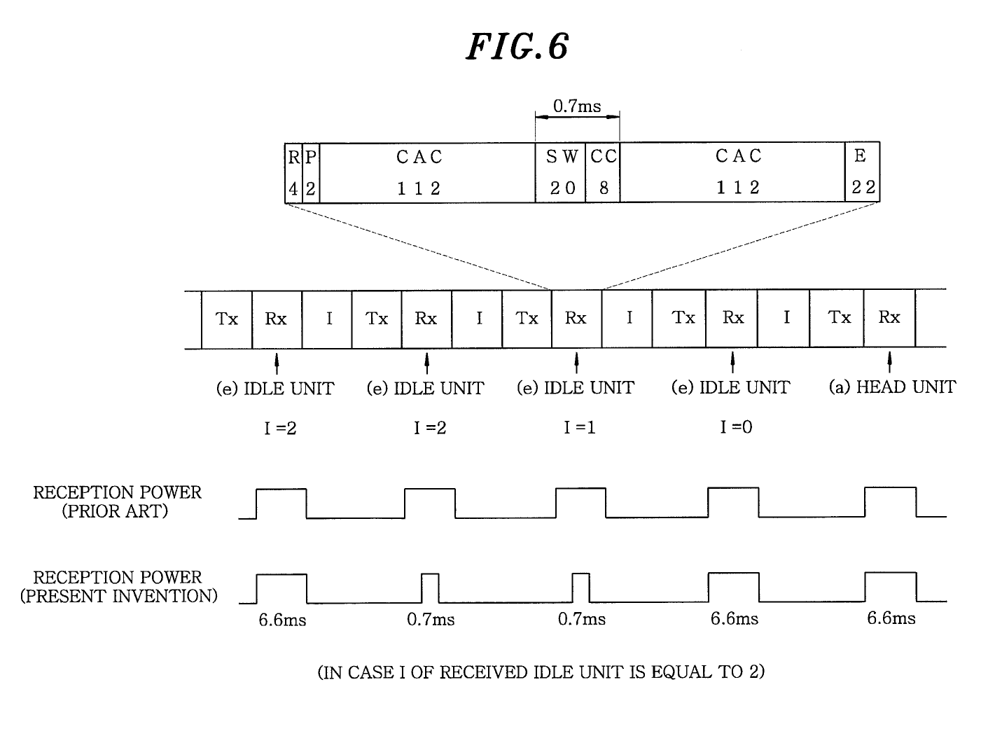

In a similar way, as shown in FIG. 6, if I of the received idle unit is equal to 2, the power control unit 11a supplies to the RF unit 12 operational power during a period of time corresponding to a portion (SW and CC) of the next two reception slots Rx's.

In the step S1, if the received data unit is found not to be an idle unit, the CPU 11b checks further whether the received data unit is a head unit or not (step S5). If the received data unit is not a head unit, the received data unit is considered as an erroneously received data unit. That is, it is assumed that a head unit preceding the received data unit is missing. In this case, the CPU lib controls the power control unit 11a to supply to the RF unit 12 operational power during a period of time corresponding to only a portion of reception slots including data units following the received data unit (step S4).

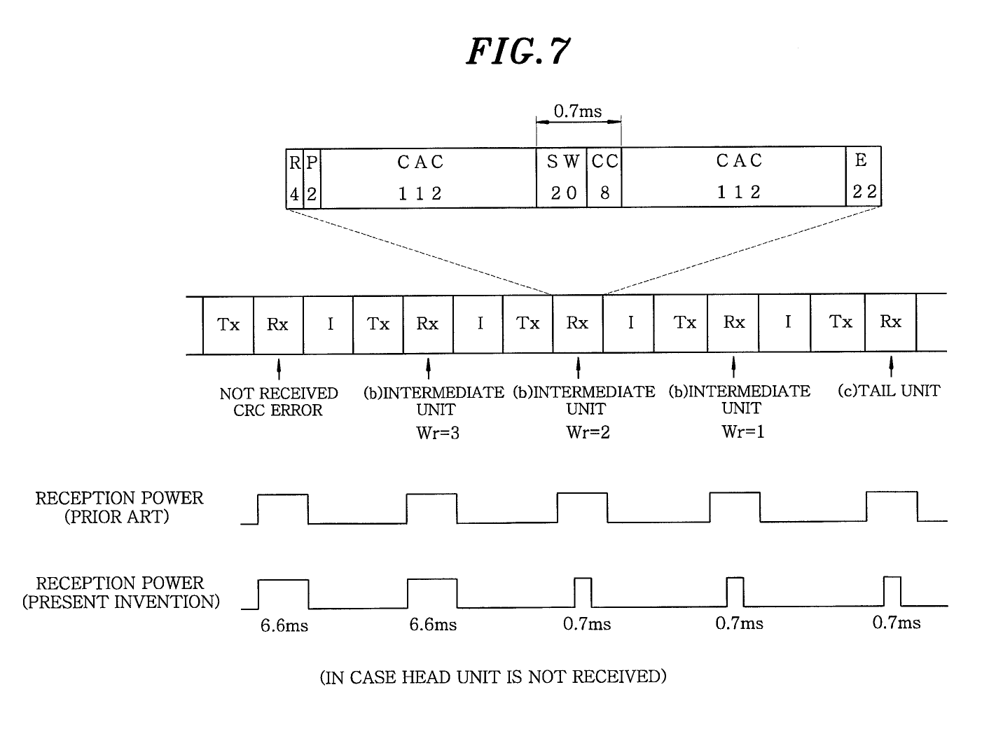

For example, referring to in FIG. 7, if a head unit is not received and an intermediate unit following the head unit is received (the number of remaining data units Wr is 3), the power control unit 11a provides the RF unit 12 with operational power during a period of time (0.7 ms) corresponding to a portion (SW and CC) of the next three reception time slots Rx's. Therefore, in comparison with the prior art which supplies operational power to the RF unit 12 during a period of time (6.6 ms) corresponding to the entire reception time slot Rx, the present invention reduces the power consumption and process overhead thereof by skipping the unnecessary data units, while retaining the necessary data.

Meanwhile, in the step S5, if the received data unit is found to be a head unit, the CPU 11b checks further whether the destination of the head unit is the mobile terminal apparatus 1 (step S6). The above process is performed based on address data included in unit data of the head unit. If the destination is not the mobile terminal apparatus 1, the CPU 11b controls the power control unit 11a to supply to the RF unit 12 operational power during a period of time corresponding to a portion of reception slots including data units following the head unit (step S4).

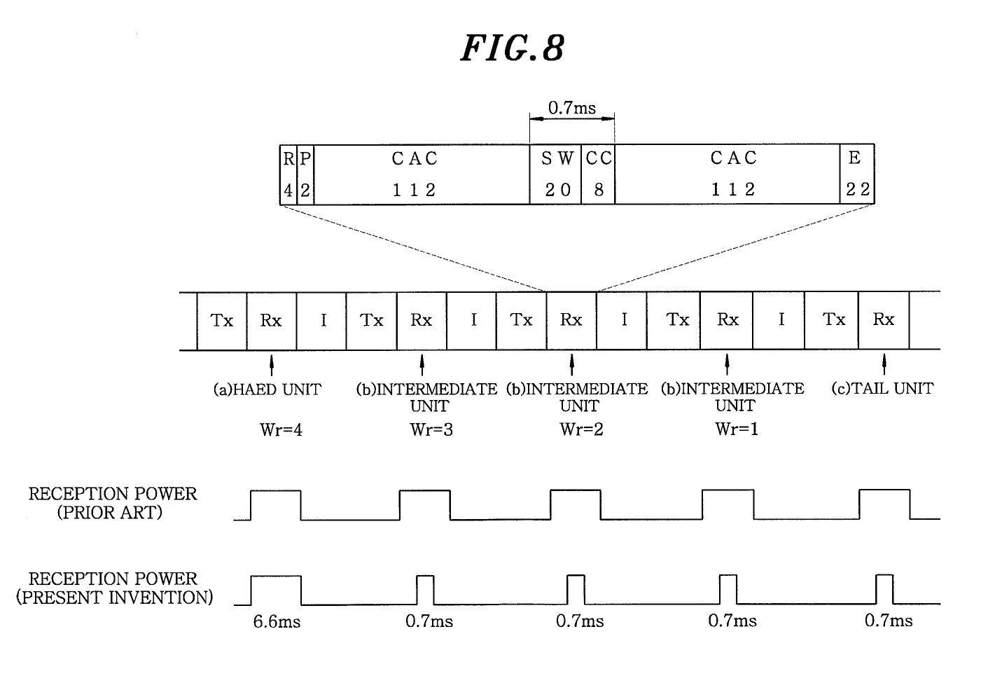

For example, referring to FIG. 8, if the destination is not the mobile terminal apparatus 1 (the number of remaining data units Wr is 4), the power control unit 11a provides the RF unit 12 with operational power during a period of time (0.7 ms) corresponding to a portion (SW and CC) of the next four reception time slots Rx's. Therefore, in comparison with the prior art which supplies operational power to the RF unit 12 during a period of time (6.6 ms) corresponding to the entire reception time slot Rx, the present invention reduces the power consumption and process overhead thereof required by bypassing the unnecessary data units, while retaining the necessary data.

In the step S6, if the destination of the head unit is found to be the mobile terminal apparatus 1, a normal reception process is performed (step S3). That is, the power control unit 11a supplies to the RF unit 12 operational power during a period of time (6.6 ms) corresponding to the whole reception slots Rx's including data units following the head unit.

Therefore, in accordance with the present invention, the power supply for the reception process in the mobile terminal apparatus is controlled to be available only during a period of time corresponding to a portion of reception slots, the portion containing data necessary to control the mobile terminal apparatus. In this way, the mobile terminal apparatus can prevent waste of power supply and reduce the reception processing overhead to thereby secure sufficient operation time.

While the invention has been shown and described with respect to the preferred embodiments, it will be understood by those skilled in the art that various changes and modifications may be made without departing from the spirit and scope of the invention as defined in the following claims.

What is claimed is:

1. A mobile terminal apparatus for receiving sequentially a first data unit and remaining data units following the first data unit, the first data unit and the remaining data units being generated by segmenting a series of user data and the first data unit including information on a destination of the first data unit, characterized in that if the information indicates that the destination is not the mobile terminal apparatus, the mobile terminal apparatus is controlled not to receive at least a portion of the remaining data units.

2. A mobile terminal apparatus for receiving sequentially a first data unit and remaining data units following the first data unit, the first data unit and the remaining data units being generated by segmenting a series of user data and including information on the respective types of the data units, characterized in that if the information indicates that the first data unit is not received by the mobile terminal apparatus, the mobile terminal apparatus is controlled not to receive at least a portion of the remaining data units.

3. A mobile terminal apparatus for receiving sequentially a first data unit and remaining data units following the first data unit, the first data unit and the remaining data units being generated by segmenting a series of user data and including information on the respective types of the data units, characterized in that if the information indicates that the first data unit is an idle unit, the idle unit containing data unavailable to the mobile terminal apparatus, the mobile terminal apparatus is controlled not to receive at least a portion of the remaining data units.

4. The mobile terminal apparatus of claim 1, which comprises:
a power control unit for controlling operational power supplied to a RF (radio frequency) unit which processes reception of the first data unit and the remaining data units, to thereby control the RF unit not to receive at least a portion of the remaining data units.

5. The mobile terminal apparatus of claim 2, which comprises:
a power control unit for controlling operational power supplied to a RF (radio frequency) unit which processes reception of the first data unit and the remaining data units, to thereby control the RF unit not to receive at least a portion of the remaining data units.

6. The mobile terminal apparatus of claim 3, which comprises:
a power control unit for controlling operational power supplied to a RF (radio frequency) unit which processes reception of the first data unit and the remaining data units, to thereby control the RF unit not to receive at least a portion of the remaining data units.
